(19) United States
(12) Patent Application Publication
(10) Pub. No.: US 2018/0000268 A1
(43) Pub. Date: Jan. 4, 2018

(54) Intelligent Knife Holder

(71) Applicant: Li Zhijian, Fujian (CN)

(72) Inventor: Li Zhijian, Fujian (CN)

(21) Appl. No.: 15/352,687

(22) Filed: Nov. 16, 2016

(30) Foreign Application Priority Data
Jun. 29, 2016 (CN) 201610494623.8
Jun. 29, 2016 (CN) 201620667282.5
Aug. 29, 2016 (CN) 201610753752.4
Aug. 29, 2016 (CN) 201620970358.1

(51) Int. Cl. A47G 21/14; E05B 73/00; G05B 15/02; G07C 9/00

(52) U.S. Cl. CPC A47G 21/14; G07C 9/00182; E05B 73/00; G07C 9/00563; G05B 15/02; A47G 2400/126; G07C 2009/00769

(57) ABSTRACT

An intelligent cutter holder apparatus, comprising: a cutter holder body; a cutter locking mechanism for locking or unlocking a cutter and the cutter holder body; a driving device for driving locking or unlocking of the cutter locking mechanism; a power supply; a control device for controlling the driving device and the power supply; and a plurality of first cutter placing holes being arranged in the top wall of the cutter holder body.

### TECHNICAL FIELD

The invention relates to a kitchen gadget, in particular an intelligent knife holder.

### BACKGROUND

In the modern society, the knife holder is one of the most common devices in the kitchen. However, the common ordinary holder is usually used for placing all kinds of knives and cutters, but not for effective management. Knives can be easily be drawn out, which results in some safety risks, such as children's touch, overturning of the holder or other unpredictable risks.

Hence, in order to better manage the family knives, it is important to lock knives in the holder.

### BRIEF DESCRIPTION OF THE INVENTION

This invention is aimed to overcome the above risks and disadvantages by providing a smart holder, which is able to safely manage knives and cutters to prevent unpredictable dangers.

The invention is realized by the following technical schemes: a smart holder, which includes the knife body, a knife locking mechanism for locking or unlocking the knife with or from the holder, driving device for driving knife locking mechanism to lock or unlock, controller which controls the driving device and power supply. On the ceiling wall of the holder are multiple first knife openings.

### BRIEF DESCRIPTION OF THE DRAWINGS

FIG. 1 is the dimensional schematic diagram of Embodiment 1;

FIG. 2: top view of the embodiment 1;

FIG. 3 is Section A-A section in FIG. 2;

FIG. 4 is the profile of Embodiment 1;

FIG. 5 is the zoom-in picture of Position B in FIG. 4;

FIG. 6 is the schematic diagram of the emergency unlocking mechanism;

FIG. 7 is the profile of Embodiment 5;

FIG. 8 is the locking state diagram of Embodiment 5.

FIG. 9 is the section view of embodiment 11;

FIG. 10 is the locking state diagram for knife holder locking mechanism of Embodiment 11;

FIG. 11 is the unlocking state diagram for knife holder locking mechanism of Embodiment 11;

FIG. 12 is the section view of Embodiment 15;

FIG. 13 is the locking state diagram for knife holder locking mechanism of Embodiment 15;

FIG. 14 is the unlocking state diagram for knife holder locking mechanism of Embodiment 15;

FIG. 15 is the section view of Embodiment 21;

FIG. 16 is the section view of Embodiment 22.

Tag declaration: 1—holder, 11—first opening, 12—controller, 13—second magnet, 14—control circuit, 2—sliding board, 21—second opening, 22—first magnet, 3—fixing isolation board, 31—third opening, 41—rack, 42—motor, 43—transmission gear, 44—driver shaft, 45—slot, 46—transmission chain wheel, 47—driving chain wheel, 48—pulley drive, 49—driving belt wheel, 5—rubber layer, 6—power supply.

### DETAILED DESCRIPTION OF THE INVENTION

Its working principle and process are as follows: Under normal conditions when the knives are inserted into the holder, the controller controls the driving device to lock the knife onto the holder. When it is necessary to get one knife out of the holder, the controller actuates the driving device to unlock the knife from the locking mechanism, so that the knife can be drawn out of the holder.

In order to better implement the program, the following optimization scheme shall also be provided: The locking mechanism of the holder contains at least two programs as below: Scheme I: the described locking mechanism is the sliding board in the knife holder, on which multiple second openings correspond to the first knife openings. The described sliding board can move in respect to the holder body to make sure the first and second openings are staggered.

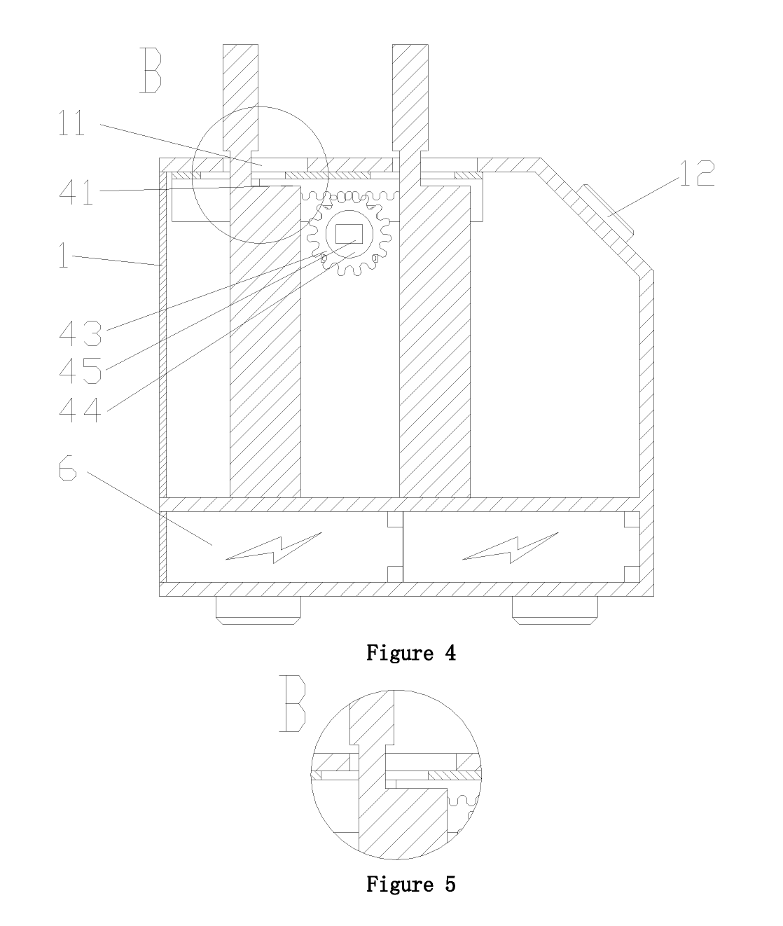

As shown in FIG. 4-5, the principle of this scheme is, through the staggering between the second and first openings, the knife will be fixed inside the holder, and then the knife can be drawn out from the holder again through the re-engagement between the first and second openings. In other words, in this scheme, through changing the size of the openings, the inserted knife after being locked cannot be drawn out from the opening.

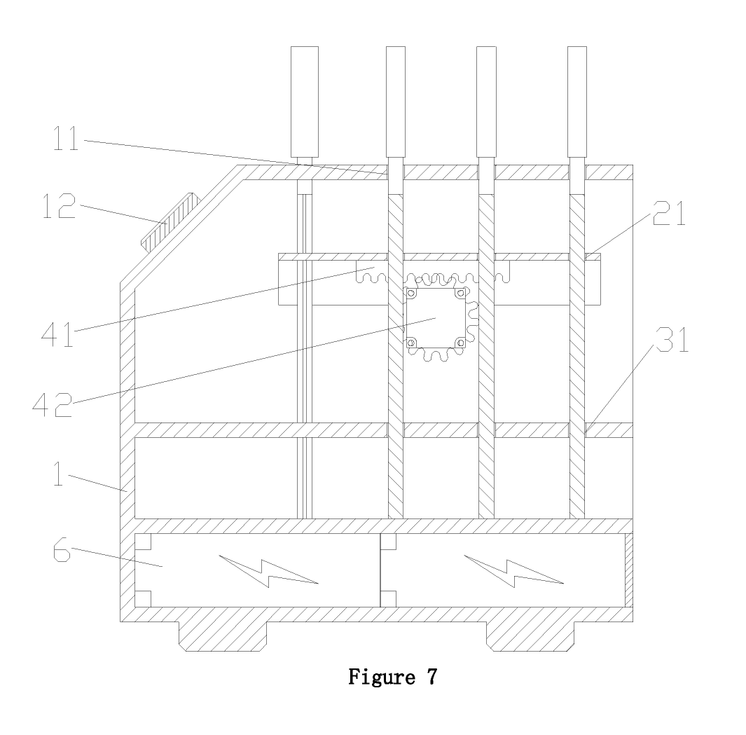

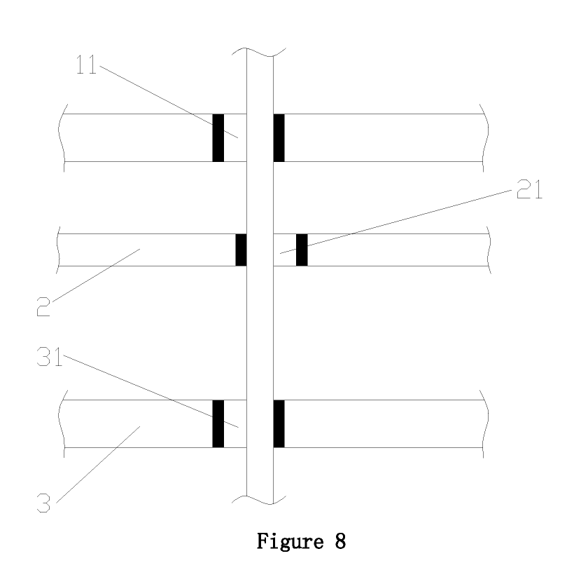

As shown in FIG. 7-8, in Scheme II, the locking mechanism of the described knife is the sliding board inside the holder as well as the internal fixing isolating board, there are multiple second openings corresponding to the first openings on the sliding board, and there are a lot of third openings corresponding to the first openings on the isolating board. The described sliding board is located between the ceiling holder wall and isolating board, which can move in respect to the ceiling holder wall to make the first and second openings and between the second openings staggered from each other.

This scheme is to restrict the level position of the knife by taking advantage of the ceiling of the holder and fixing isolation board. The knife goes through the corresponding first, second and third openings, and the driving device is actuated to drive the sliding board and compress the knife onto the side wall in the first and third openings, so that the three openings will “hold” the knife; Compared to Scheme I, this scheme mainly has the following two advantages: Advantage 1: this Scheme is different from Scheme I, and it is aimed to “hold” the knife by the movement of the sliding board. Therefore, this scheme will not be restricted by the knife shape, so most knives or cutters can be locked, including scissors and files that are quite different from regular knives; Advantage 2: because of two limiting positions, i.e. the ceiling wall and the fixing isolation board, so once the knife is inserted, it will keep straight and stable.

The driving device may contain at least the following schemes: Scheme I: the described driving device comprises the rack at the lower surface of the sliding board as well as the motor below the sliding board; The motor is provided with a gear, and the motor actuates the sliding board to move laterally through the engagement between the gear and rack. Scheme II: the described driving device comprises the first magnet set at the sliding board, the second magnet set at the relative position of the side wall inside the knife holder body and the magnetism switching mechanism controlling the attraction or repulsion produced between the first magnet and second magnet. The described magnetism switching mechanism controls horizontal reciprocating slide of sliding board to the top wall of the knife holder body by switching the attraction or repulsion produced between the first magnet and second magnet. The locking principle of Scheme II is as follows: When attraction is produced between the first magnet and the second magnet, attracted by the second magnet, the first magnet actuates the sliding board to move towards to the inner wall with the second magnet to make the first openings and second openings, the second openings and the third openings staggered from each other as well as move the sliding board and compress the knife onto the side wall in the first and third openings, so that the three openings will “hold” the knife; when repulsion is produced between the first magnet and the second magnet, repulsed by the second magnet, the first magnet actuates the sliding board to move backward to the inner wall of the knife holder body to reset the sliding board to unlock the knife. In Scheme II, control method of magnet may contain at least the following two optional sub-schemes: Sub-scheme I: adoption of permanent magnet. The described first magnet and second magnet are permanent magnets, and the two poles of the first magnet are located at the upper and lower ends. The described magnetism switching mechanism is rack arranged at the second magnet and motor arranged at the internal side wall of knife holder body; the described motor is equipped with transmission gear, and the engagement between transmission gear and rack moves the second magnet back and forth vertically. Pole of the second magnet is distributed up and down. Relative pole of the second magnet and the first magnet is changed through the vertical movement of the second magnet driven by the motor. Based on the physics principle, two like poles repel and vice versa for the purpose of locking or unlocking of the knife locking mechanism. Sub-scheme II: adoption of the electromagnet. The described second magnet is the electromagnet and the first magnet is the permanent magnet. The described magnetism switching mechanism is the control circuit for controlling the magnetism of the second magnet. Control the circuit to control the magnetism of the second magnet to further control the attraction or repulsion between the second magnet and the first magnet to finally achieve the purpose of locking or unlocking of the knife locking mechanism. Electric energy of the electromagnet can be provided by the power supply or be the separately-designed power supply. Scheme III: The described driving device comprises the rack at the lower surface of the sliding board, driving chain wheel engaged with the rack, as well as the motor below the sliding board; the described motor is equipped with driving chain wheel. Driving chain wheel actuates the transmission chain wheel through chain, and then moves the sliding board back and forth. Scheme IV: The described driving device comprises the rack at the lower surface of the sliding board, pulley drive engaged with the rack, as well as the motor below the sliding board; the described motor is equipped with driving belt wheel. Driving belt wheel actuates the pulley drive through belt, and then moves the sliding board back and forth.

Further, the described driving device may have the rack at the lower surface of the sliding board as well as the motor below the sliding board; The motor is provided with a gear, and the motor actuates the sliding board to move laterally through the engagement between the gear and rack.

Meanwhile, the controller used for locking or unlocking of the locking mechanism has the following feasible schemes in this invention: Scheme I: the described controller is the fingerprint identification device which is used for controlling the locking or unlocking of the tool locking mechanism. Scheme II: the described controller is the NFC device which is used for controlling the locking or unlocking of the tool locking mechanism. Scheme III: the described controller is the RFID device which is used for controlling the locking or unlocking of the tool locking mechanism. Scheme IV: the described controller is the image identification device which is used for controlling the locking or unlocking of the tool locking mechanism. Scheme V: the described controller is the voice identification device which is used for controlling the locking or unlocking of the tool locking mechanism. Scheme VI: the described controller is a card and the card slot. When the card is inserted into the slot, the driving device is controlled to unlock the knife from the holder. When the card is withdrawn from the slot, the driving device is controlled to lock the knife and holder together. Scheme VII: the described controller is a key and the corresponding lock. When the lock is opened, the driving device is controlled to unlock the knife from the holder. When the lock is locked, the driving device is controlled, the driving device is controlled to lock the knife and holder together.

Moreover, it also includes a mobile terminal for remotely controlling the locking/unlocking of the knife locking mechanism. APPs are installed onto the mobile terminal through the programmed program on the APP and preset locking/locking conditions, including but not limited to distance conditions, time length conditions, buttons, etc. Through the WIFI network or Bluetooth or GSM wireless communications, the APP communicates information with the chip main board on the holder and transmits instructions to the chip on the holder, and the chip further drives the movement of the driving mechanical equipment, in order to manage and control the locking/unlocking of the holder by APP.

APP can also be equipped with a switch button to control the instruction button. APP has the following two modes: 1. Automatic mode: when the APP is an open state, the mobile terminal is near the knife holder, and APP, through the WIFI, Bluetooth, GSM or other wireless communications, gives the instructions to the main board mounted on the knife holder, and the main board drives the mechanical equipment to achieve the unlocking function. When the APP of the mobile terminal reaches the preset knife holder locking conditions, the APP will issue instructions to the chip on the knife holder, and the chip further actuates the mechanical device to lock.

When the APP opens and set at an automatic locking, the mobile terminal APP will acquire the signals issued by the holder chip main board at a certain interval. The distance between the mobile terminal and holder is determined according to the signal value. When this distance reaches the preset unlocking condition signal value, the APP will send unlocking instruction to the main control chip of the circuit board, the driving mechanical device is used to unlock the holder. When the distance between the mobile terminal and knife holder is beyond the preset signal value, the APP will give the instruction to the main control chip to actuate the mechanical device to lock.

When the APP opens and set to automatically unlock, the mobile terminal APP will automatically detect the signal value given by the main chip on the holder, and automatically check the time length in the unlocking state. When the time length reaches or exceeds the preset length, the APP issues the instructions to the main control chip to the circuit board, the chip drives the mechanical device to set the holder at the locking state.

2. Manual mode: the mobile terminal is installed with the APP which has the corresponding locking button module. When the unlocking/locking button is clicked, the APP issues an instruction to the main control chip on the holder, and the chip drives a mechanical device to unlock or lock.

Further, there shall be at least the following schemes for remotely controlling the locking or unlocking of the controller by cooperating with the mobile terminal: Scheme I: the described controller is a Bluetooth device when Bluetooth for communicating with the mobile terminal. When the Bluetooth device receives the unlocking order given by the mobile terminal, the knife will be unlocked from the holder. When the Bluetooth device receives the locking order given by the mobile terminal, it will control the driving device to lock the knife and holder together. Scheme II: the described controller is a WIFI device when Bluetooth for communicating with the mobile terminal. When the WIFI device receives the unlocking order given by the mobile terminal, the knife will be unlocked from the holder. When the WIFI device receives the locking order given by the mobile terminal, it will control the driving device to lock the knife and holder together. Scheme III: the described controller is a GSM device when Bluetooth for communicating with the mobile terminal. When the GSM device receives the unlocking order given by the mobile terminal, the knife will be unlocked from the holder. When the GSM device receives the locking order given by the mobile terminal, it will control the driving device to lock the knife and holder together.

Furthermore, in order to automatically control the locking of the knife locking mechanism, the function for simplifying the operations by users includes: delay module which is used for delay control to lock the knife and holder. The working process is as follows: when the invented product is unlocked, the time delay module is started to time. When the preset time is reached, the control main board is ordered to lock the knife locking mechanism automatically. Further, in order to increase the friction between the knife and openings and make the tool locking more secure: The upper ring of the inner walls is provided with a rubber layer for the first, second and/or third openings.

Further, the power supply has at least two of the following schemes: Scheme I: the power supply is fed by rechargeable batteries. Scheme II: the power supply is fed by plugs. Scheme III: the power supply is fed by button batteries.

At the same time, the scheme must ensure the knife will not be locked and cannot be drawn out from the holder in case of unexpected power failure. The described knife also includes the emergency unlocking mechanism to unlock the holder in case of power failure, which connects the transmission gear shaft and drives the gear rotation to reset the sliding board for unlock the emergency unlocking.

Moreover, the described emergency unlocking mechanism is the driver shaft connected with the transmission gear shaft on one end, and the other end of the driver shaft is provided with a slot that is exposed on the holder. The cross section of the slot is provided with special shape, such as triangle, pentagon, trapezoid and other geometrical shape, or provided with irregular shapes. Finally, the dedicated unlocking tool whose cross section matches with the slot cross section is used to insert for unlocking.

Compared with the prior technology, the beneficial effects of the invention are: 1. After the knife is inserted into the holder, it will be automatically locked, so that the knife is well and safely managed; 2. Through the mobile terminal, the knife can be locked remotely and used easily; 3. The invented product is applicable to the knife of any shape and can be locked securely.

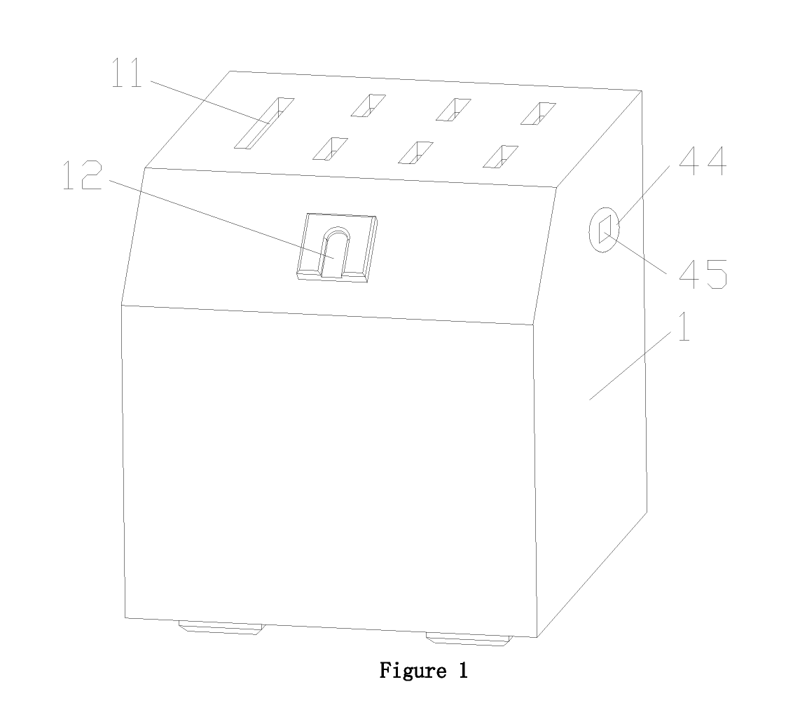

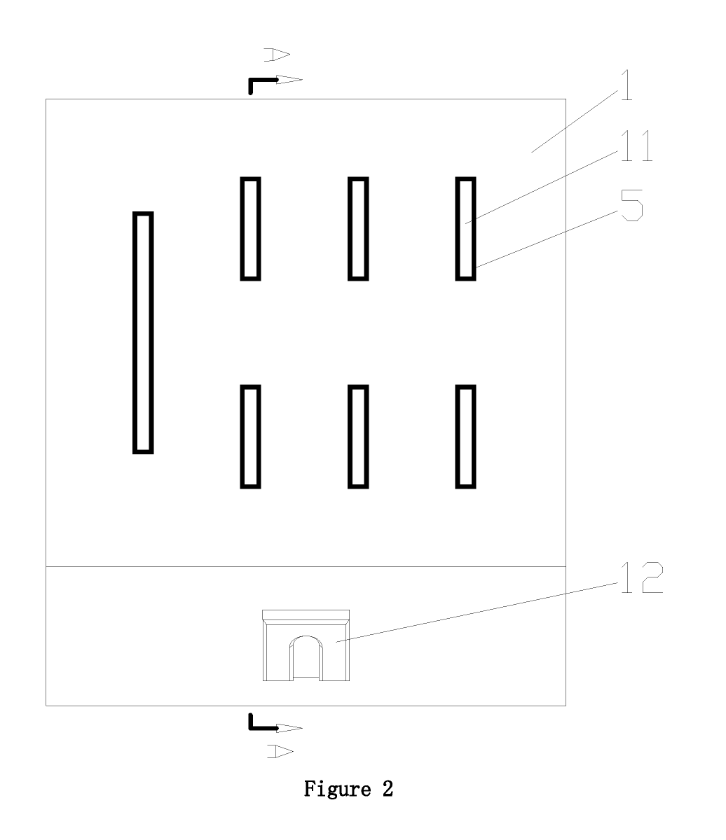

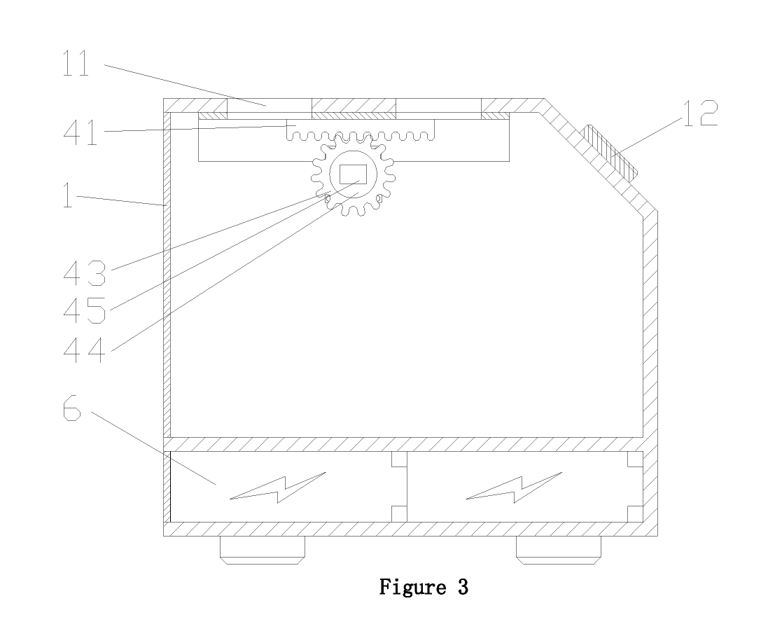

This invention is described by texts with illustrations: Embodiment 1: As shown in FIG. 1-5, this embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The described locking mechanism is the sliding board 2 in the knife holder 1, on which multiple second openings 21 correspond to the first knife openings 11. The described sliding board 2 can move in respect to the holder body 1 to make sure the first openings 11 and second openings 21 are staggered. The described driving device comprises the rack 41 at the lower surface of the sliding board as well as the motor 42 below the sliding board. The described motor 42 has the transmission gear 43, and the sliding board moves back and forth by engagement between the transmission gear 43 and rack 41.

The described controller 12 is the fingerprint identification device which is used for controlling the locking or unlocking of the tool locking mechanism. The described power supply 6 is the chargeable battery. It also includes the emergency unlocking mechanism to unlock the holder in case of power failure, and the said emergency unlocking mechanism is connected with the transmission gear shaft 43 to drive the transmission gear 43 to reset the sliding board 2.

The described emergency unlocking mechanism is the driver shaft 44 connected with the transmission gear shaft 43 on one end, and the other end of the driver shaft 44 is provided with a slot 45 that is exposed on the holder 1.

### Embodiment 2

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The described locking mechanism is the sliding board 2 in the knife holder 1, on which multiple second openings 21 correspond to the first knife openings 11. The described sliding board 2 can move in respect to the holder body 1 to make sure the first openings 11 and second openings 21 are staggered. The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. The described controller 12 is the NFC device which is used for controlling the locking or unlocking of the tool locking mechanism. The described power supply 6 is the chargeable battery.

### Embodiment 3

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The described locking mechanism is the sliding board 2 in the knife holder 1, on which multiple second openings 21 correspond to the first knife openings 11. The described sliding board 2 can move in respect to the holder body 1 to make sure the first openings 11 and second openings 21 are staggered. The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. The described controller 12 is the RFID device which is used for controlling the locking or unlocking of the tool locking mechanism. The described power supply 6 is the chargeable battery.

### Embodiment 4

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11. The described locking mechanism is the sliding board 2 in the knife holder 1, on which multiple second openings 21 correspond to the first knife openings 11. The described sliding board 2 can move in respect to the holder body 1 to make sure the first openings 11 and second openings 21 are staggered.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. The described controller 12 is the image identification device which is used for controlling the locking or unlocking of the tool locking mechanism. The upper ring of the inner walls is provided with a rubber layer 5 for the first openings 11, second openings 21 and/or third openings 31. The described power supply 6 is the chargeable battery.

### Embodiment 5

As shown in FIG. 7-8, this embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. The described controller 12 is the voice identification device which is used for controlling the locking or unlocking of the tool locking mechanism. The upper ring of the inner walls is provided with a rubber layer 5 for the first openings 11, second openings 21 and/or third openings 31. The described power supply 6 is the chargeable battery.

### Embodiment 6

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. The described controller 12 is a card and the card slot. When the card is inserted into the slot, the driving device is controlled to unlock the knife from the holder 1. When the card is withdrawn from the slot, the driving device is controlled to lock the knife and holder 1 together. The upper ring of the inner walls is provided with a rubber layer 5 for the first openings 11, second openings 21 and/or third openings 31. The power supply is fed by button batteries.

### Embodiment 7

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41.

The described controller 12 is a key and the corresponding lock. When the lock is opened, the driving device is controlled to unlock the knife from the holder 1. When the lock is locked, the driving device is controlled, the driving device is controlled to lock the knife and holder 1 together. The power supply is fed by button batteries.

### Embodiment 8

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. It also includes a mobile terminal for remotely controlling the locking/unlocking of the knife locking mechanism.

The described controller 12 is a Bluetooth device when Bluetooth for communicating with the mobile terminal. When the Bluetooth device receives the unlocking order given by the mobile terminal, the knife will be unlocked from the holder 1. When the Bluetooth device receives the locking order given by the mobile terminal, it will control the driving device to lock the knife and holder 1 together. The power supply is fed by button batteries.

### Embodiment 9

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41. It also includes a mobile terminal for remotely controlling the locking/unlocking of the knife locking mechanism.

The described controller 12 is a WIFI device when WIFI for communicating with the mobile terminal. When the WIFI device receives the unlocking order given by the mobile terminal, the knife will be unlocked from the holder 1. When the Bluetooth device receives the locking order given by the mobile terminal, it will control the driving device to lock the knife and holder 1 together. The described power supply 6 is the plug of the power supply 6.

### Embodiment 10

This embodiment includes the knife body 1, a knife locking mechanism for locking or unlocking the knife with or from the holder 1, driving device for driving knife locking mechanism to lock or unlock, controller 12 which controls the driving device and power supply 6. On the top wall of the holder 1 are multiple first knife openings 11.

The locking mechanism of the described knife is the sliding board 2 inside the holder 1 as well as the fixing isolating board 3 inside the holder 1, there are multiple second openings 21 corresponding to the first openings on the sliding board 2, and there are a lot of third openings corresponding to the first openings on the isolating board 3. The described sliding board 2 is located between the ceiling of the holder 1 and isolating board 3, which can move in respect to the ceiling of the holder 1 to make the first openings 11 and second openings 21 and between the second openings 21 and second openings 31 staggered from each other.

The described driving device comprises the rack 41 at the lower surface of the sliding board as well as the motor 42 below the sliding board; The described motor 42 has the transmission gear 43, and the sliding board moves back and forth by engagement between the transmission gear 43 and rack 41.

It also includes a mobile terminal for remotely controlling the locking/unlocking of the knife locking mechanism. The described controller 12 is a GSM device when GSM for communicating with the mobile terminal. When the GSM device receives the unlocking order given by the mobile terminal, the knife will be unlocked from the holder 1. When the Bluetooth device receives the locking order given by the mobile terminal, it will control the driving device to lock the knife and holder 1 together.

Furthermore, in order to automatically control the locking of the knife locking mechanism, the function for simplifying the operations by users includes: delay module which is used for delay control to lock the knife and holder 1. The described power supply 6 is the plug of the power supply 6.

### Embodiment 11

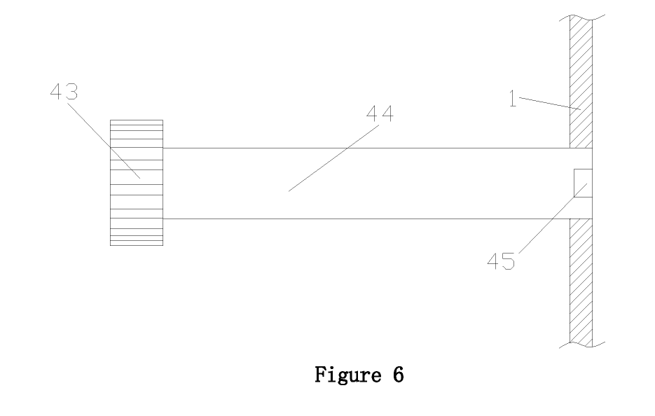

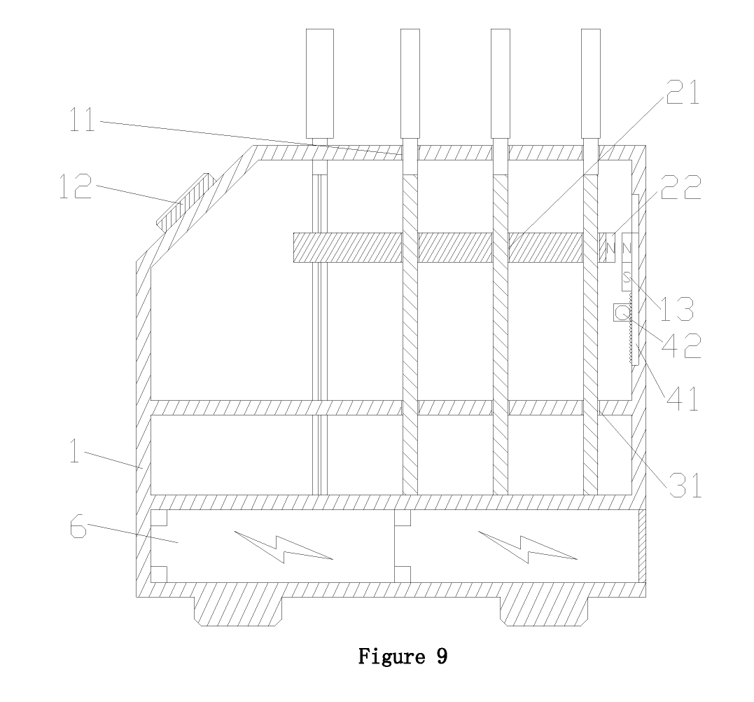

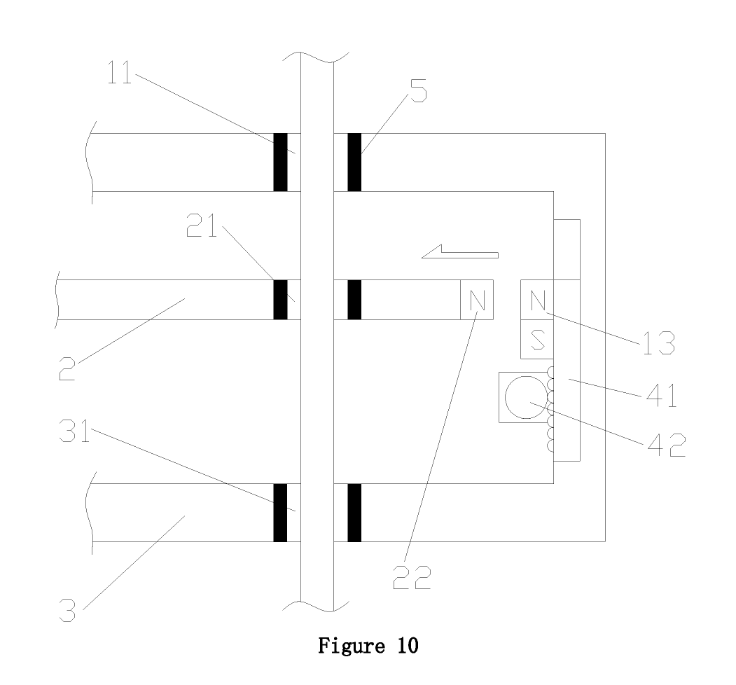

As shown in FIG. 9-11, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21, the second openings 21 and second openings 31 staggered from each other; The described driving device comprises the first magnet 22 set at the sliding board 2, the second magnet 13 set at the relative position of the side wall inside the knife holder body 1 and the magnetism switching mechanism controlling the attraction or repulsion produced between the first magnet 22 and second magnet 13. The described magnetism switching mechanism controls horizontal reciprocating slide of sliding board 2 to the top wall of the knife holder 1 body by switching the attraction or repulsion produced between the first magnet 22 and second magnet 13. The described first magnet 22 and second magnet 13 are permanent magnets, and the two poles of the first magnet 13 are located at the upper and lower ends. The described magnetism switching mechanism is rack 41 arranged at the second magnet and motor 42 arranged at the internal side wall of knife holder body 1; the described motor 42 is equipped with transmission gear 43, and the engagement between transmission gear 43 and rack 41 moves the second magnet 13 back and forth vertically. The described controller 12 is the fingerprint identification device which is used for controlling the locking or unlocking of the tool locking mechanism. The described power supply 6 is the chargeable battery. As shown in FIG. 6-8, it also includes the emergency unlocking mechanism for unlocking the knife holder in case of power-fail, and the emergency unlocking mechanism being connected with the shaft of the transmission gear 43 to rotate the transmission gear 43 and reset the sliding plate 2. The described emergency unlocking mechanism is the driver shaft 44 connected with the transmission gear shaft 43 on one end, and the other end of the driver shaft 44 is provided with a slot 45 that is exposed on the holder body 1.

### Embodiment 12

As shown in FIG. 9-11, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described first magnet 22 and second magnet 13 are permanent magnets, and the two poles of the first magnet 13 are located at the upper and lower ends. The described magnetism switching mechanism is rack 41 arranged at the second magnet 13 and motor 42 arranged at the internal side wall of knife holder body 1; the described motor 42 is equipped with transmission gear 43, and the engagement between transmission gear 43 and rack 41 moves the second magnet 13 back and forth vertically. The described controller 12 is the NFC device which is used for controlling the locking or unlocking of the tool locking mechanism. The described power supply 6 is the chargeable battery.

### Embodiment 13

As shown in FIG. 9-11, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described first magnet 22 and second magnet 13 are permanent magnets, and the two poles of the first magnet 13 are located at the upper and lower ends. The described magnetism switching mechanism is rack 41 arranged at the second magnet 13 and motor 42 arranged at the internal side wall of knife holder body 1; the described motor 42 is equipped with transmission gear 43, and the engagement between transmission gear 43 and rack 41 moves the second magnet 13 back and forth vertically. The described controller 12 is the RFID device which is used for controlling the locking or unlocking of the tool locking mechanism. The described power supply 6 is the chargeable battery.

### Embodiment 14

As shown in FIG. 9-11, This embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described first magnet 22 and second magnet 13 are permanent magnets, and the two poles of the first magnet 13 are located at the upper and lower ends. The described magnetism switching mechanism is rack 41 arranged at the second magnet and motor 42 arranged at the internal side wall of knife holder body 1; the described motor 42 is equipped with transmission gear 43, and the engagement between transmission gear 43 and rack 41 moves the second magnet 13 back and forth vertically. The described controller 12 is the image identification device which is used for controlling the locking or unlocking of the tool locking mechanism. The upper ring of the inner walls is provided with a rubber layer 5 for the first openings 11, second openings 21 and/or third openings 31. The described power supply 6 is the chargeable battery.

### Embodiment 15

As shown in FIG. 8-10, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. The described controller 12 is the voice identification device which is used for controlling the locking or unlocking of the tool locking mechanism. The upper ring of the inner walls is provided with a rubber layer 5 for the first openings 11, second openings 21 and/or third openings 31. The described power supply 6 is the chargeable battery.

### Embodiment 16

As shown in FIG. 9-11 this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. The described controller 12 comprises a card and a slot used for placing card. When the card is inserted into the slot, the driving device is controlled to unlock the knife from the knife holder body 1. When the card is withdrawn from the slot, the driving device is controlled to lock the knife and knife holder body 1 together. The upper ring of the inner walls is provided with a rubber layer 5 for the first openings 11, second openings 21 and/or third openings 31. The power supply is fed by button cell.

### Embodiment 17

As shown in FIG. 9-11, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. The described controller 12 comprises a key and a lock corresponding to the key. When the lock is opened, the driving device is controlled to unlock the knife from the knife holder body 1. When the lock is locked and the driving device is controlled, the driving device is controlled to lock the knife and holder body 1 together. The power supply is fed by button cell.

### Embodiment 18

As shown in FIG. 9-11, This embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. It also comprises a mobile terminal for remotely controlling the locking or unlocking of the knife locking mechanism. The described controller 12 is a Bluetooth device used for communication with the mobile terminal. When the Bluetooth device receives the unlocking order given by the mobile terminal, the knife will be unlocked from the holder body 1. When the Bluetooth device receives the locking order given by the mobile terminal, it will control the driving device to lock the knife and holder body 1 together. The power supply is fed by button cell.

### Embodiment 19

As shown in FIG. 9-11 this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. It also comprises a mobile terminal for remotely controlling the locking/unlocking of the knife locking mechanism. The described controller 12 is a WIFI device for communicating with the mobile terminal. When the WIFI device receives the unlocking order given by the mobile terminal, the knife will be unlocked from the knife holder body 1. While the WIFI device receives the locking order given by the mobile terminal, the knife will be locked from the knife holder body 1. The described power supply 6 is the plug of the power supply 6.

### Embodiment 20

As shown in FIG. 9-11, this embodiment includes the knife body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first knife openings 11; The locking mechanism of the described knife is the sliding board 2 inside the knife holder body 1 as well as the fixing isolating board 3 inside the knife holder body 1, there are multiple second openings 21 corresponding to the first openings 11 on the sliding board 2, and there are multiple third openings 31 corresponding to the first openings 11 on the fixing isolating board 3. The described sliding board 2 is located between the top wall of the holder body 1 and fixing isolating board 3, which can move in respect to the top wall of the holder body 1 to make the first openings 11 and second openings 21 staggered from each other; The described driving device comprises the first magnet 22 arranged on the sliding board 2, the second magnet 13 arranged at the corresponding place of knife holder body 1 internal side wall and the magnetism switching mechanism used for controlling the attraction and repulsion between the first magnet 22 and the second magnet 13. The described magnetism switching mechanism controls the sliding board 2 moving back and forth laterally relative to the top wall of the knife holder body 1 through switching the attraction and repulsion between the first magnet 22 and the second magnet 13. The described second magnet 13 is electromagnet and the first magnet 22 is permanent magnet. The described magnetism switching mechanism is the control circuit 14 used for controlling the magnetism of the second magnet 13. It also comprises a mobile terminal for remotely controlling the locking/unlocking of the knife locking mechanism. The described controller 12 is a GSM device when GSM for communicating with the mobile terminal. When the GSM device receives the unlocking order given by the mobile terminal, the knife will be unlocked from the holder body 1. When the Bluetooth device receives the locking order given by the mobile terminal, it will control the driving device to lock the knife and holder body 1 together. Delay module which is used for delay control to lock the knife and holder body 1. The described power supply 6 is the plug of the power supply 6.

### Embodiment 21

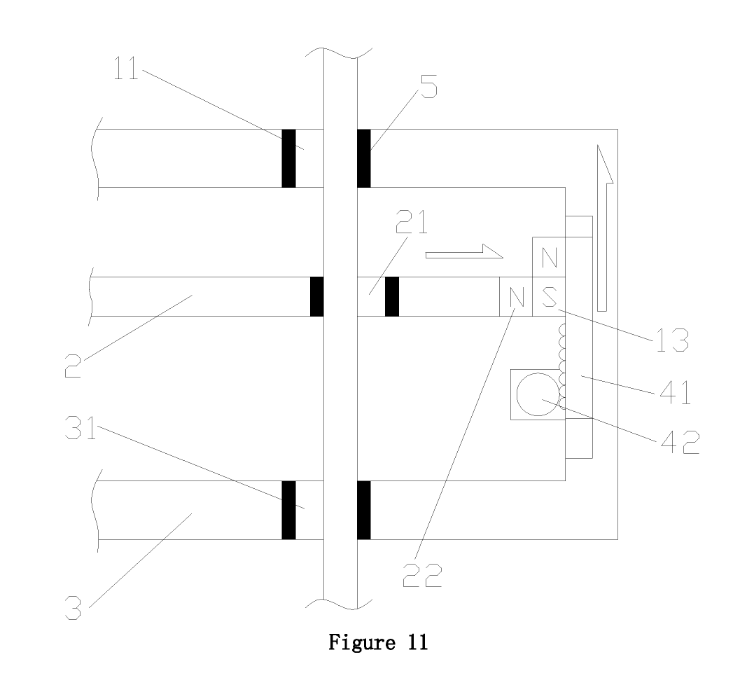

As shown in FIG. 11, this embodiment comprises the knife holder body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first opening 11; The locking mechanism of the described knife is the sliding board 2 inside the holder body 1 as well as the fixing isolating board 3 inside the holder body 1, there are multiple second openings 21 corresponding to the openings on the sliding board 2, and there are multiple third openings 31 corresponding to the openings on the isolating board 3. The described sliding board 2 is located between the top wall of the holder body 1 and isolating board 3, which can move in respect to the top wall of the holder body 1 to make the first openings 11 and second openings 21, the second openings 21 and second openings 31 staggered from each other; The described driving device comprises the rack 41 at the lower surface of the sliding board 2, transmission chain wheel 46 engaged with rack, as well as the motor 42 below the sliding board 2; The described motor 42 is equipped with driving chain wheel 47. Driving chain wheel 47 actuates the transmission chain wheel 46 through chain, and then moves the sliding board 2 back and forth.

### Embodiment 22

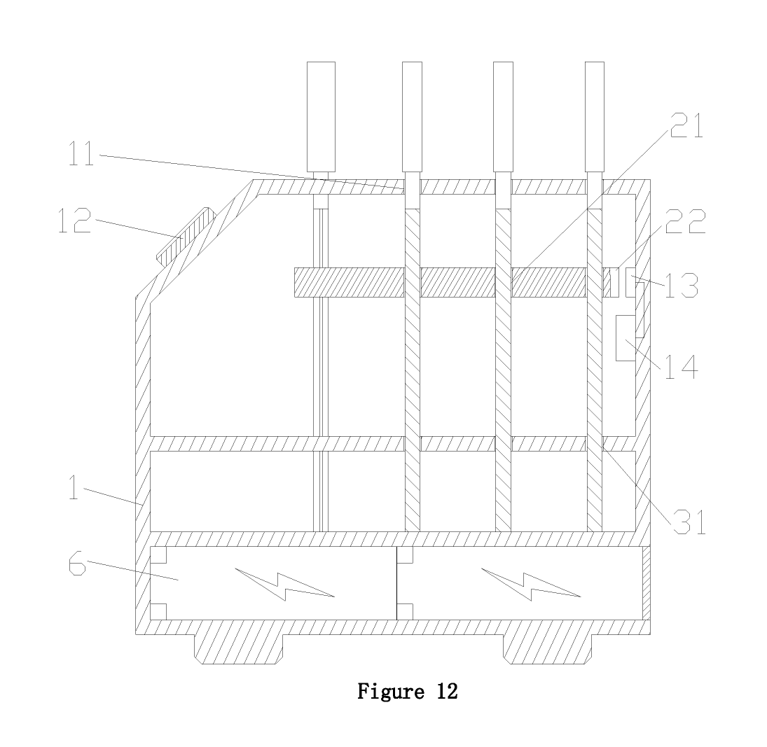

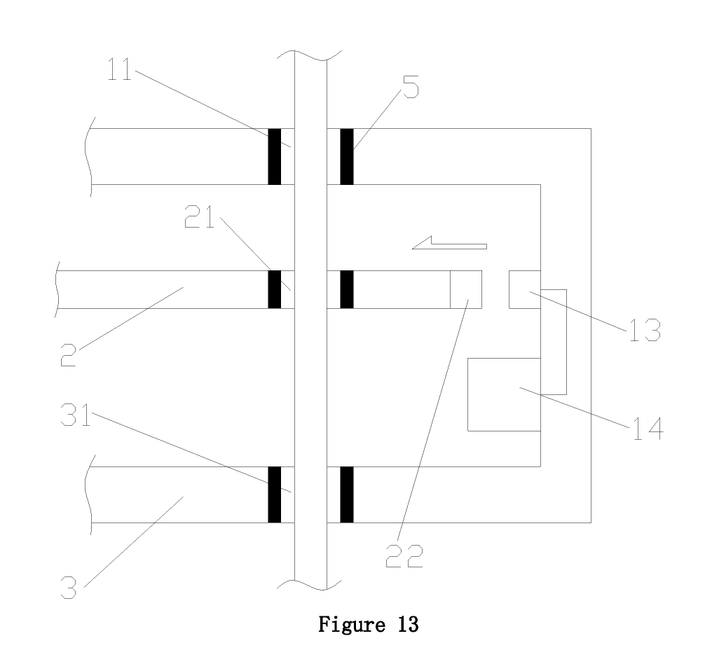

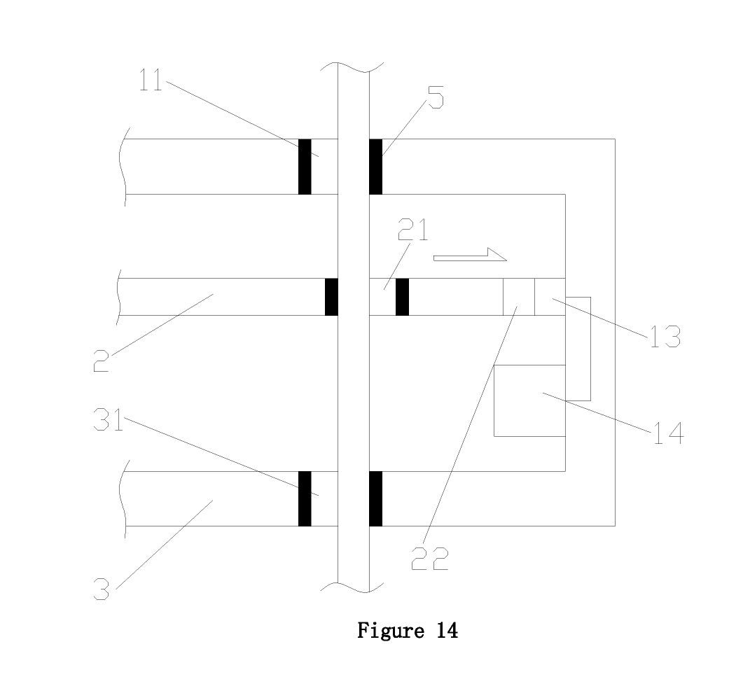

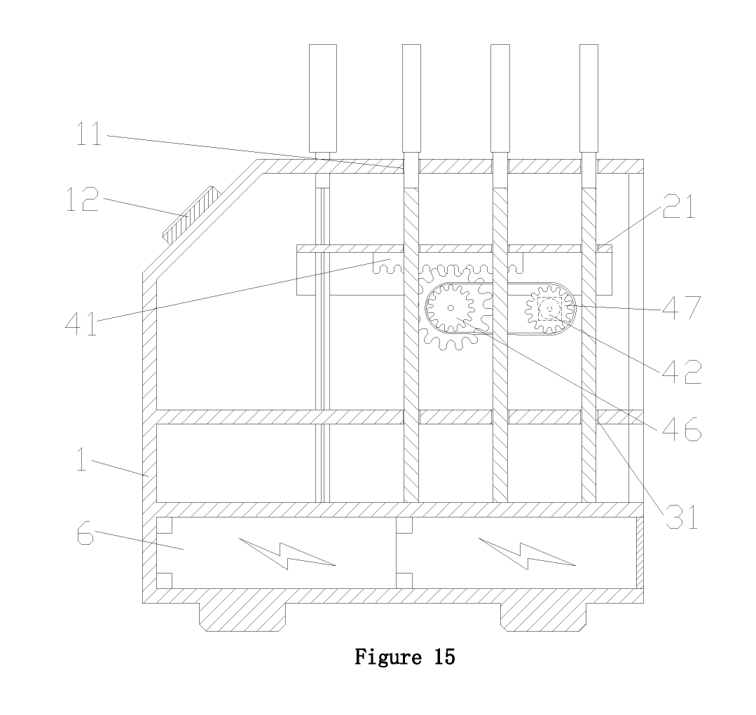

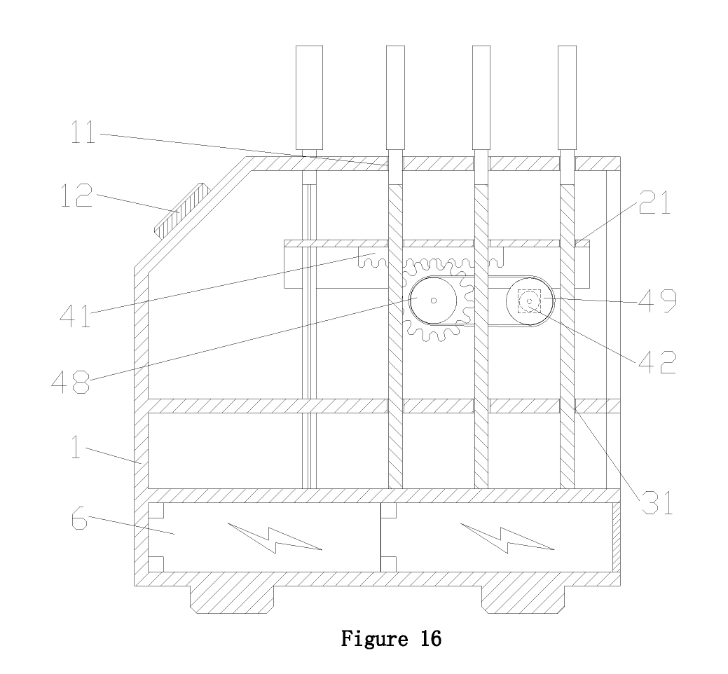

As shown in FIG. 12, this embodiment comprises the knife holder body 1, a knife locking mechanism for locking or unlocking the knife with or from the holder body 1, driving device for driving knife locking mechanism to lock or unlock, controller 12 which controls the driving device and power supply 6. On the top wall of the holder body 1 are more than 1 first opening 11; The described locking mechanism comprises the sliding board 2 slidably arranged in the knife holder body 1 and a fixing isolating board 3 fixedly arranged in the knife holder body 1, multiple second openings 21 corresponding to the openings are arranged on the sliding board 2; multiple third openings 31 corresponding to the openings are arranged on the fixing isolating board 3; the sliding board 2 is arranged between the top wall of the knife holder body 1 and the fixing isolating board 3, and can move relative to the top wall of the knife holder body 1 so as to make the first openings 11 and the second openings 21 mismatched; The described driving device comprises the rack 41 at the lower surface of the sliding board 2, transmission belt 48 engaged with rack, as well as the motor 42 below the sliding board 2; The described motor 42 is equipped with driving belt 49. Driving belt 49 actuates the transmission belt 48 through belt, and then moves the sliding board 2 back and forth.

Although the specific embodiments and alternative proposals are used to illustrate this invention, it is understandable that any changes or modifications are acceptable as long as they do not deviate from the essence of this invention. Therefore, it should be noted that this invention should not be restricted in any case except the attached claims and equivalent limitations.

I claim:

1. An intelligent cutter holder apparatus, comprising:
a cutter holder body;
a cutter locking mechanism for locking or unlocking a cutter and the cutter holder body;
a driving device for driving locking or unlocking of the cutter locking mechanism;
a power supply;
a control device for controlling the driving device and the power supply; and
a plurality of first cutter placing holes being arranged in the top wall of the cutter holder body.

2. The intelligent cutter holder apparatus according to claim 1, wherein the cutter locking mechanism is a sliding plate slidably arranged in the cutter holder body and further comprising:
a plurality of second cutter placing holes arranged on the sliding plate and corresponding to the plurality of first cutter placing holes, wherein the sliding plate can move relative to the top wall of the cutter holder body to make the plurality of first cutter placing holes and the plurality of second cutter placing holes mismatched.

3. The intelligent cutter holder apparatus according to claim 1, wherein the cutter locking mechanism is a sliding plate slidably arranged in the cutter holder body and further comprising:
a fixed baffle fixedly arranged in the cutter holder body;
a plurality of second cutter placing holes arranged on the sliding plate and corresponding to the plurality of first cutter placing holes;
a plurality of third cutter placing holes arranged on the fixed baffle and corresponding to the plurality of first cutter placing holes;
wherein the sliding plate is arranged between the top wall of the cutter holder body and the fixed baffle and can move relative to the top wall of the cutter holder body so as to make the plurality of first cutter placing holes and the plurality of second cutter placing holes mismatched, and make the plurality of second cutter placing holes and the plurality of third cutter placing holes mismatched.

4. The intelligent cutter holder apparatus according to claim 2, wherein the driving device comprises a rack arranged on the lower surface of the sliding plate and a motor arranged under the sliding plate; a transmission gear is arranged on the motor, and the transmission gear is engaged with the rack to move the sliding plate back and forth.

5. The intelligent cutter holder according to claim 3, wherein the driving device comprises a first magnet arranged on the sliding plate, a second magnet arranged at a corresponding place of the cutter holder body at an internal side wall and a magnetic switching mechanism used for controlling the attraction and repulsion between the first magnet and the second magnet.

6. The intelligent cutter holder according to claim 5, wherein the magnetic switching mechanism controls the sliding plate moving back and forth laterally relative to the top wall of the cutter holder body by switching the attraction and repulsion between the first magnet and the second magnet.

7. The intelligent cutter holder according to claim 5, wherein the first magnet and the second magnet are permanent magnets, and two poles of the first magnet are located at an upper end and a lower end.

8. The intelligent cutter holder according to claim 7, wherein the magnetic switching mechanism comprises a rack arranged at the second magnet and a motor arranged at the internal side wall of cutter holder body, wherein the motor is equipped with a transmission gear and the engagement between transmission gear and the rack moves the second magnet back and forth vertically.

9. The intelligent cutter holder according to claim 5, wherein the second magnet is electromagnet and the first magnet is a permanent magnet and wherein the magnetic switching mechanism is a control circuit used for controlling the magnetism of the second magnet.

10. The intelligent cutter holder according to claim 2, wherein the driving device comprises a rack arranged on a lower surface of the sliding plate, a transmission chain wheel engaged with a rack and a motor arranged under the sliding plate; a driving chain wheel is arranged on the motor, wherein the driving chain wheel actuates rotation of the transmission chain wheel and then moves the sliding plate back and forth.

11. The intelligent cutter holder according to claim 3, wherein the driving device comprises a rack arranged on a lower surface of the sliding plate, a transmission chain wheel engaged with a rack and a motor arranged under the sliding plate; a driving chain wheel is arranged on the motor, wherein the driving chain wheel actuates rotation of the transmission chain wheel and then moves the sliding plate back and forth.

12. The intelligent cutter holder according to claim 2, wherein the driving device comprises a rack arranged on a lower surface of the sliding plate, a transmission belt wheel engaged with a rack and a motor arranged under the sliding plate; a driving belt wheel is arranged on the motor, wherein the driving belt wheel actuates rotation of the transmission belt wheel and then moves the sliding plate back and forth.

13. The intelligent cutter holder according to claim 3, wherein the driving device comprises a rack arranged on a lower surface of the sliding plate, a transmission belt wheel engaged with a rack and a motor arranged under the sliding plate; a driving belt wheel is arranged on the motor, wherein the driving belt wheel actuates rotation of the transmission belt wheel and then moves the sliding plate back and forth.

14. The intelligent cutter holder apparatus according to claim 1, wherein the control device is a fingerprint recognition device for controlling locking or unlocking of the cutter locking mechanism.

15. The intelligent cutter holder apparatus according to claim 1, wherein the control device is an NFC device for controlling locking or unlocking of the cutter locking mechanism.

16. The intelligent cutter holder apparatus according to claim 1, wherein the control device is an RFID device for controlling locking or unlocking of the cutter locking mechanism.

17. The intelligent cutter holder apparatus according to claim 1, wherein the control device is an image recognition device for controlling locking or unlocking of the cutter locking mechanism.

18. The intelligent cutter holder apparatus according to claim 1, wherein the control device is a voice recognition device for controlling locking or unlocking of the cutter locking mechanism.

19. The intelligent cutter holder apparatus according to claim 1, wherein the control device is a plug-in card and a card slot for placing the plug-in card; when the plug-in card is inserted into the card slot, the driving device is controlled to unlock the cutter and the cutter holder body; when the plug-in card is pulled from the card slot, the driving device is controlled to lock the cutter and the cutter holder body.

20. The intelligent cutter holder apparatus according to claim 1, wherein the control device is a key and a lock corresponding to the key; when the lock is opened, the driving device is controlled to unlock the cutter and the cutter holder body; when the lock is locked, the driving device is controlled to lock the cutter and the cutter holder body.

21. The intelligent cutter holder apparatus according to claim 1, further comprising a mobile terminal for controlling locking or unlocking of the cutter locking mechanism.

22. The intelligent cutter holder apparatus according to claim 16, wherein the control device is a Bluetooth device which is communicated with the mobile terminal; when the Bluetooth device receives the unlocking command given by the mobile terminal, the driving device is controlled to unlock the cutter and the cutter holder body; when the Bluetooth device receives the locking command given by the mobile terminal, the driving device is controlled to lock the cutter and the cutter holder body.

23. The intelligent cutter holder apparatus according to claim 16, wherein the control device is a WIFI device which is communicated with the mobile terminal; when the WIFI device receives the unlocking command given by the mobile terminal, the driving device is controlled to unlock the cutter and the cutter holder body; when the WIFI device receives the locking command given by the mobile terminal, the driving device is controlled to lock the cutter and the cutter holder body.

24. The intelligent cutter holder apparatus according to claim 16, wherein the control device is a GSM device which is communicated with the mobile terminal; when the GSM device receives the unlocking command given by the mobile terminal, the driving device is controlled to unlock the cutter and the cutter holder body; when the GSM device receives the locking command given by the mobile terminal, the driving device is controlled to lock the cutter and the cutter holder body.

25. The intelligent cutter holder apparatus according to claim 1, further comprising a delay module for delayed control of locking the cutter and the cutter holder body.

26. The intelligent cutter holder apparatus according to claim 1, further comprising rubber layers annularly arranged on inner wall surfaces of at least one of the plurality of first cutter placing holes, the plurality of second cutter placing holes and the plurality of third cutter placing holes.

27. The intelligent cutter holder apparatus according to claim 1, wherein the power supply is rechargeable battery, battery socket or button cell.

28. The intelligent cutter holder apparatus according to claim 4, further comprising an emergency unlocking mechanism for unlocking the cutter holder in case of power-fail, and the emergency unlocking mechanism being connected with a shaft of the transmission gear to rotate the transmission gear and reset the sliding plate.

29. The intelligent cutter holder apparatus according to claim 23, wherein the emergency unlocking mechanism is a rotating shaft and one end of the rotating shaft is connected with the shaft of the transmission gear and the other end of the rotating shaft is provided with a hole slot which is exposed out of the cutter holder body.

30. The intelligent cutter holder apparatus according to claim 3, wherein the driving device has a rack arranged on the lower surface of the sliding plate and a motor arranged under the sliding plate; wherein a transmission gear is arranged on the motor, and the transmission gear is engaged with the rack to move the sliding plate back and forth.

31. The intelligent cutter holder apparatus according to claim 4, further comprising an emergency unlocking mechanism for unlocking the cutter holder in case of power-fail, wherein the emergency unlocking mechanism is connected with a shaft of the transmission gear to rotate the transmission gear and reset the sliding plate.

32. The intelligent cutter holder apparatus according to claim 26, wherein the emergency unlocking mechanism is a rotating shaft, one end of the rotating shaft is connected with a shaft of the transmission gear and the other end of the rotating shaft is provided with a hole slot which is exposed out of the cutter holder body.
